(19) United States
(12) Patent Application Publication
(10) Pub. No.: US 2011/0093696 A1
(43) Pub. Date: Apr. 21, 2011

(54) DEVICE AND METHOD FOR DIRECTING EXCHANGE FLOWS FOR PUBLIC OR NON SENSITIVE VALUES FOR CREATING COMMON SECRET KEYS BETWEEN AREAS

(76) Inventor: Eric Grall, Brest (FR)

(21) Appl. No.: 12/682,764

(22) PCT Filed: Oct. 10, 2008
(86) PCT No.: PCT/EP08/63609

§ 371 Date: Jan. 6, 2011

(30) Foreign Application Priority Data
Oct. 12, 2007 (FR) 0707180

(51) Int. Cl. H04L 9/06

(52) U.S. Cl. 713/153

(57) ABSTRACT

A method and a system for routing exchange flows of public or non-sensitive values for creating common keys between a number of areas in a system in which the entities communicate with each other by trust group, including: each entity generates a public value and communicates this public value to a router; the router, having a mapping table correlating a virtual network number and the MAC addresses of the associated entities, recovers all the public addresses transmitted by the entities by associating them with their MAC address, and retransmits, to each of the entities, a public value of another entity belonging to the same trust group; each entity recovering the public value of another entity belonging to the same trust group then determines the value of the encryption key common to the entities of one and the same trust group; and uses this key to encrypt the data to be transmitted to another entity.

The invention relates to a device and a method for routing exchange flows for public or non-sensitive values for creating common secret keys between a number of areas.

It applies to the fields of telecommunications, and notably to the security partitioning between certain IP network domains (IP being the abbreviation for Internet Protocol).

It can also be used in a system in which a number of entities can communicate by trust group or partitioning group, notably in the software domain or the hardware architecture domain.

In systems comprising areas that have a number of confidentiality levels or even partitions for identical confidentiality levels, it is often necessary to provide rules and means with which to manage the circulation of the data flows exchanged between the areas.

For example, in the field of telecommunication networks comprising a number of areas with different security levels, the systems use, for example, a network administrator to supply the first secrets (private and public keys generated by a KMI, Key Management Infrastructure) which will be used to create the partitioning between the areas delimited by certain network elements, whether these are routers or switches.

One of the problems to be resolved in this field is therefore the capability of the network administrator to accomplish this task. To the knowledge of the Applicant, currently, the partitioning is managed either by a router filtering the IP packets with respect to a specific routing table, or by a switch, by the virtual network configuration at level 2 of the OSI layer via the implementation of IEEE directive 802.1P,Q, IEEE standards 802.1p—Traffic Class Expediting and Dynamic Multicast Filtering (published in 802.1D-1998) and 802.1Q—Virtual LANs) (utilization ref doc: article: author: E.NICLAS, IEEE 802.1 P,Q—QoS on the MAC level.

These techniques, although effective, do not always make it possible to obtain a strong partitioning between the network areas associated with the routing elements (layer 2/3) of the IP network. In this context, only cryptographic protection provides the strong partitioning property, and therefore one that cannot be modified by a hacker internal to the network.

In this context, the broadcasting of encryption or integrity keys is then necessary and increases the complexity in implementing network elements (switches or routers). In the conventional case of an IP network, a key management infrastructure must be implemented in order to create and broadcast public and private keys between the various elements of the network to be partitioned. It is thus possible to use the management infrastructure-based key management method, better known by the abbreviation KMI (Key Management Infrastructure), which uses an organizational method to distribute the common secret to the elements forming part of the same virtual network.

The main drawback of the prior art is the obligation for an IT department to have a key management infrastructure, and to configure the level 2 or 3 routing elements each time it is placed in service.

To secure layer 2 of the OSI standard, the standard RFC 802.1 P,Q makes it possible, in the case of an Ethernet network, to provide the capacity to create virtual private networks by parameterizing a network number associated with a delimited area of the network by Ethernet switches. One of the drawbacks is not having an adequate security level in the event of modification of the parameters of the standard 802.P,Q and therefore in the event of reassignment of the network numbers associated with one or more areas. This standard therefore does not provide for securing of the partitioning between the configured switching elements.

The present invention relates to an element that makes it possible to independently configure security between entities that are required to communicate with each other, by trust or partitioning group.

It also provides an independent mechanism for negotiating group keys between the abovementioned various entities in order to be able to create, from the elements, a cryptographic filtering of the flows circulating in their respective domains.

The invention relates to a method for routing exchange flows for public or non-sensitive values for creating common keys between a number of areas in a system in which the entities communicate with each other by trust group, characterized in that it comprises at least the following steps:
each entity generates a public value and communicates this public value to a router,
said router has a mapping table correlating a virtual network number and the MAC addresses of the associated entities,
said router recovers all the public addresses transmitted by the entities by associating them with their MAC address, and retransmits, to each of said entities associated with a virtual network based on the mapping table of each entity, a public value of another entity belonging to the same trust group, this step being repeated for all the entities,
each entity recovering the public value of another entity belonging to the same trust group then determines the value of the encryption key common to the entities of one and the same trust group,
an entity belonging to one and the same trust group uses this key to encrypt the data to be transmitted to another entity.

The invention relates to a system for routing exchange flows of public or non-sensitive values for creating common keys between a number of areas, in a system in which the entities communicate with each other by trust group, characterized in that it comprises at least the following elements:
an entity comprises a cryptography module suitable for generating a public value and a common secret,
a routing device comprising a mapping table establishing the links that exist between the virtual network numbers and the MAC addresses of the associated entities,
communication means between the routing device and the entities so that an entity transmits a public value to the routing device, said routing device transmits said public value to another entity belonging to the same confidentiality group and an entity determines the value of the key to encrypt its data.

Other features and benefits of the present invention will become more apparent on reading the following description of an exemplary embodiment, given as a non-limiting illustration, with appended figures which represent:

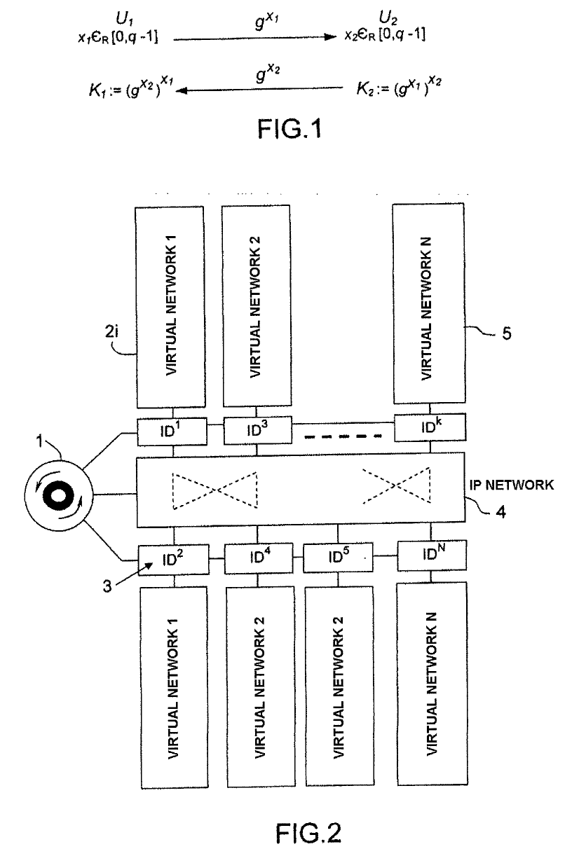

FIG. 1, a review of the Diffie-Hellman protocol mechanism,

FIG. 2, a system architecture implementing the router according to the invention,

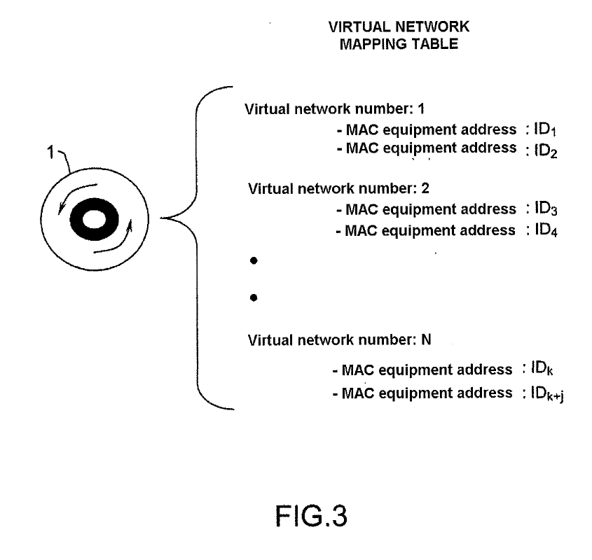

FIG. 3, a possible mapping table correlating a virtual network and MAC (Medium Access Control) addresses of network elements,

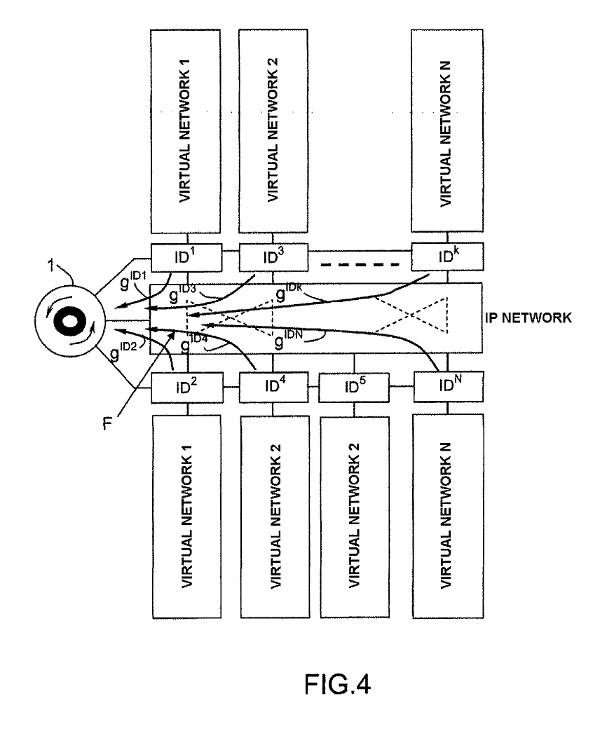

FIG. 4, the scheme for sending Diffie-Hellman public values to the router according to the invention,

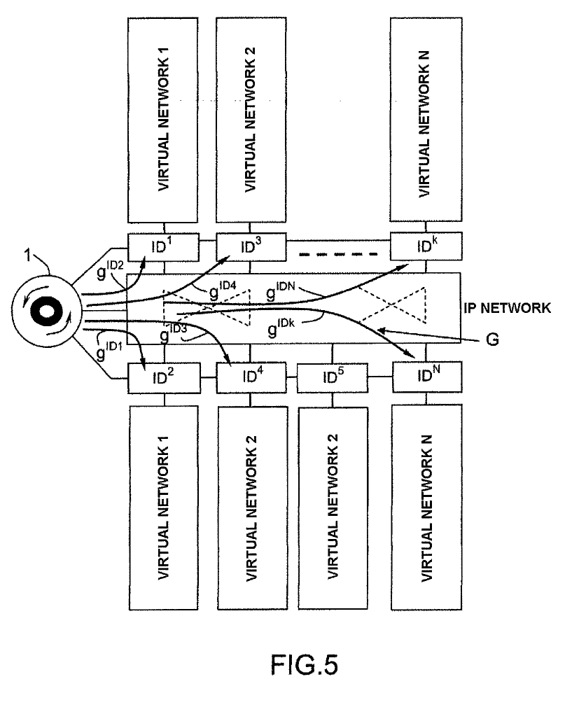

FIG. 5, the routing of the Diffie-Hellman public values by the router,

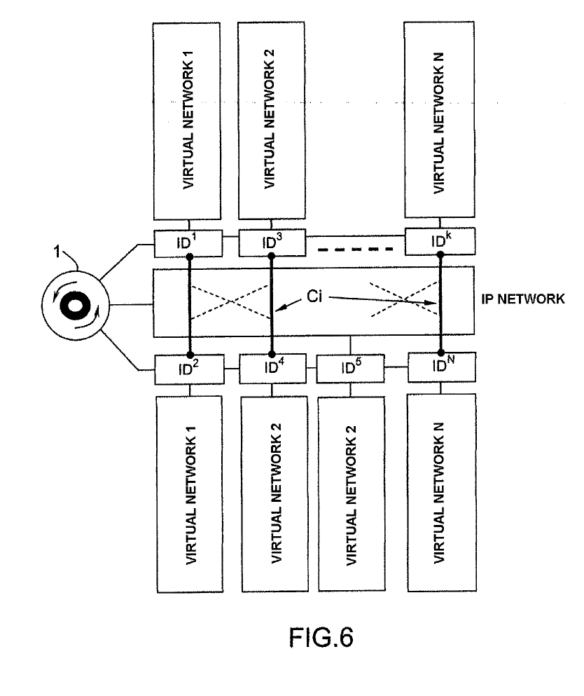

FIG. 6, a first example of generated secured virtual networks,

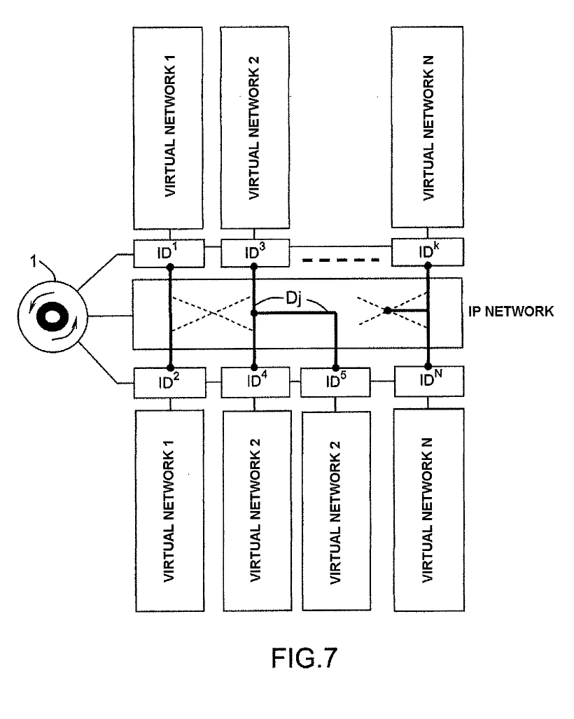

FIG. 7, a second example of secured virtual networks,

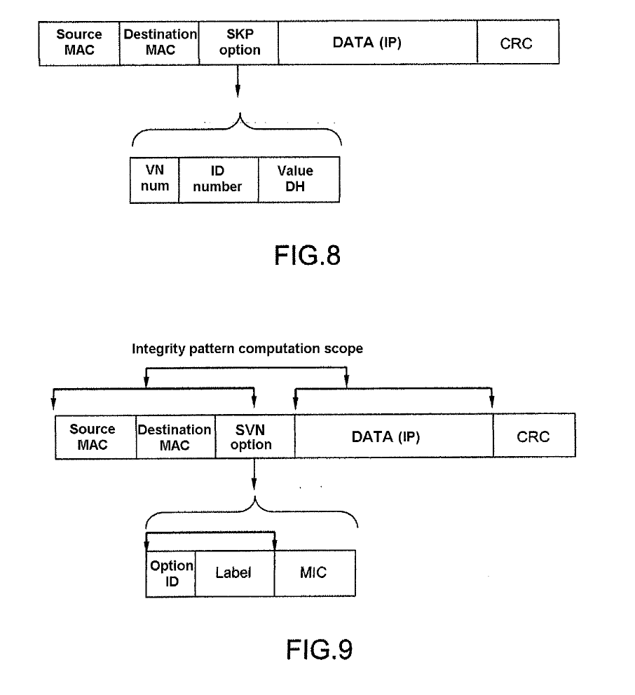

FIG. 8, the Ethernet frame format incorporating the securing option, and

FIG. 9, the format of a frame incorporating the integrity computation option.

In order to better understand the object of the invention, the following description is given in the context of an IP network. The invention can, however, be applied wherever there are entities that can communicate with each other, by trust or partitioning group. The router according to the invention makes it possible to create trust groups and direct the public values of each of the entities in order to enable them to generate a secret element associated with each of the groups.

FIG. 1 reviews the Diffie-Hellman or D-H protocol, the principles of which are described in the article published by Diffie-Hellman in 1976, under the title “New Directions in Cryptography”, IEEE Trans. On Information Theory, Vol. IT-22-6, November 1976. The main result of this article is the possibility for two users communicating via an unsafe network to agree on a session key, intended to encode their subsequent communications.

Let G=<g> be a cyclical group. The two participants U₁, U₂ each choose, at random, x₁,x₂ belonging to G respectively and exchange the values g^{x1}, g^{x2} over the network. The user U₁, (respectively U₂) then computes the Diffie-Hellman secret g^{x1x2} by receiving the message from U₂ (respectively U₁). This hypothesis stipulates that, given three values g^{x1}, g^{x2}, g^{r}, a polynomial adversary cannot decide with a significant advantage whether g^{r}=g^{x1x2} or not.

The following example is based on the Diffie-Hellman principle which gives the possibility for two users communicating with each other to agree on a session key, intended to encrypt or render integral their future communications. In the context of the invention, this approach is extended to a group of the Diffie-Hellman principle which enables a user group to generate a common session key.

FIG. 2 represents an exemplary architecture incorporating the mechanism and the router according to the invention comprising:

A router 1 or configuration module connected to a network consisting of several entities, 2i, each entity 2i communicating with the router 1 via modules 3i whose function is notably to control the passage and the direction of the data flows from one entity to another entity. The network implements, for example, the internet protocol IP. The router and the various entities communicate with each other via, for example, a switch 4 which enables the entities to be connected to one another based on configuration data from the router. The design of this switch is known to those skilled in the art and will therefore not be detailed in this patent application.

The router 1 is characterized, for example by means of its MAC (Medium Access Control) address and its IP internet address, in the example. It comprises means for managing group rules and the associated protocol. It is designated “router”. An encryption (or cryptography) module in the form of software or a circuit (in other words hardware) is incorporated in each of the elements or entities 2i of the network. The function of this encryption module 5 is notably to make it possible to implement the Diffie-Hellman protocol or any other similar protocol, for each entity, and to compute the group secret value DH for the common secret. An entity is, for example, characterized by its MAC address and has cryptography capabilities.

The device according to the invention in this example implements a protocol on Ethernet layer 2, incorporating a number of fields characterizing the identification of a virtual network generated by the router, and the integrity patterns of the level 2 frame.

The “router” element 1 has a set of rules for the creation of virtual networks. For this, it has a mapping table described in FIG. 3 correlating the virtual network numbers and the MAC addresses of the associated entities.

The way the invention operates for virtual networks formed by pairs of entities (common case) is defined in a number of phases:

Each of the entities of the network generates a secret or Diffie-Hellman public value g^{IDi}, then each of the entities sends a message to the router with its Diffie-Hellman public value g^{IDi}. The transmitted messages are diagrammatically represented in FIG. 4 by arrows F, an arrow being indexed with a public value g^{IDi}.

The router 1 then recovers all the public values transmitted by the entities by associating them with their MAC address:

Thus the public value g^{ID1} is associated with the address MAC₁ of the entity 1 and so on for the subsequent entities 2 to N, g^{ID2}, address MAC₂, g^{IDN}, address MAC_{N}.

The router then returns, to each of the entities, the Diffie-Hellman value corresponding to the entities associated with a virtual network (forming the trust network) based on the mapping table of each entity. This is represented in FIG. 5, by the arrows G indexed with the Diffie-Hellman value as follows, for example:

For the virtual network 1, the addresses of the entities 1 and 2 belonging to this network=MAC₁|MAC₂

To the address MAC₁: the router transmits the public value generated by the entity 2 g^{ID2}

To the address MAC₂: the router transmits the public value generated by the entity 1 g^{ID1}

For the virtual network2=MAC₃|MAC₄

To address MAC₄: g^{ID3}

To address MAC₃: g^{ID4}

The frame format used is, for example, the format described in FIG. 8. The frame comprises the following fields: a source MAC field, a destination MAC field, an SKP field corresponding to the securing option, a data field DATA and an error check or CRC field. The field SKP comprises, for example, the VN number (virtual network number), the identifier of the entities belonging to the virtual network concerned and the Diffie-Hellman value generated by an entity. Each of the entities recovers the Diffie-Hellman value of the entity associated with the same virtual network and uses this value to compute the secret common to the entities belonging to one and the same virtual network. For example, in FIG. 5:

For the entity ID1 (MAC₁) and ID2 (MAC₂), the entity 1 computes the common secret g^{ID1 ID2}, ID1 (MAC₁):(g^{ID2})^{ID1}->g^{ID1 ID2}; the entity 2, ID2 (MAC₂):(g^{ID1})^{ID2}->g^{ID1 ID2}

And so on for all the entities;

For the entity ID3 (MAC₃) and ID4 (MAC₄)

ID3 (MAC₃):(g^{ID4})^{ID3}->g^{ID3 ID4}; ID4 (MAC₄):(g^{ID3})^{ID4}->g^{ID3 ID4} . . . .

For the entity with address MAC_{N}: g^{IDN} g^{IDk}

Each of the entities then computes the integrity pattern based on a hashing algorithm of SHA1 type described, for example, in reference FIPS 180-2 “Federal Information Processing Standards Publications”: FIPS PUB 180-2-Secure Hash Standard (SHS)—2002 August, and incorporates it in the ETHERNET frame in order to define the partitioning between the virtual networks through verification of the integrity pattern. This step is represented in FIG. 6. The partitioning of the networks is represented by solid lines Ci which link, for example, the addresses ID¹ and ID², the virtual network that is formed corresponding to the virtual network 1, and so on.

The parameters defining the virtual network and its security will take the form of an option to be inserted into the Ethernet v2 type format. The format is, for example, that described in FIG. 9. Compared to the frame of FIG. 8, the SKP field is replaced with an SVN (Secured Virtual Network) field which comprises the identifier ID, the label and the message integrity control, or “MIC”.

At the end of the abovementioned steps, each of the modules controlling the direction of the flows between the entities has all the security information enabling it to secure the flows passing through its routing module (via the creation of a common key by the DH mechanism).

Similarly, in the case of a virtual network with more than 2 elements, the routing element will have to send the public values defined by the pairs formed by the network entities by repeating the above phase in order for each entity to be able to compute the Diffie-Hellman group secret. In this context, the way the invention operates is therefore defined in a number of phases described hereinbelow:

Each of the entities of the network generates a Diffie-Hellman secret g^{IDi}, then each of the entities will send a message to the router with its Diffie-Hellman public value g^{IDi} (FIG. 4).

The router will recover all the values of the entities by associating them with their MAC address:

g^{ID1}, address MAC₁
g^{ID2}, address MAC₂
g^{IDN} address MAC_{N}

The router will exchange (according to the format in FIG. 8), with each of the entities, the Diffie-Hellman value with respect to the entities associated with a virtual network based on its mapping table (FIG. 5).

Virtual network 1=MAC₁|MAC₂

To address MAC₁: g^{ID2}
To address MAC₂: g^{ID1}

Virtual network 2=MAC₃|MAC₄|MAC₅

To address MAC₄: g^{ID3}
To address MAC₃: g^{ID4}
To address MAC₅: g^{ID4}

Virtual network 2=MAC_{K}|MACₖ₊₁|MACₖ₊₂| . . . |MAC_{N} . . . .

Each of the entities will then recover the Diffie-Hellman value of the entity associated with the same virtual network and will use this value to compute a first common secret, and will return this value to the router as long as the number of public secrets received is different from the number of parties to the virtual network.

For the entity ID1 (MAC₁) and ID2 (MAC₂)

ID1 (MAC₁):(g^{ID2})^{ID1}->g^{ID1 ID2}; ID2 (MAC₂):(g^{ID1})^{ID2}->g^{ID1 ID2}

For the entity ID3 (MAC₃) and ID4 (MAC₄):

ID3 (MAC₃):(g^{ID4})^{ID3}->g^{ID4 ID3}; ID4 (MAC₄):(g^{ID3})^{ID4}->g^{ID3 ID4}

For the entity ID4 (MAC₄) and ID5 (MAC₅)

ID4 (MAC₄):(g^{ID5})^{ID4}->g^{ID4 ID5}; ID5 (MAC₅):(g^{ID4})^{ID5}->g^{ID4 ID5}

For the entity ID3 (MAC₃) and ID5 (MAC₅)

ID3 (MAC₃):(g^{ID5})^{ID3}->g^{ID3 ID5}; ID5 (MAC₅):(g^{ID3})^{ID5}->g^{ID3 ID5}

Each of the entities will then return this value to the router as long as the number of public secrets received is not equal to the number of parties to the virtual network. The routing device will then route these values to the entity forming part of the network in order to finalize the group value.

For the entity ID1 (MAC₁) and ID2 (MAC₂)

For the entity ID3 (MAC₃) (g^{ID4 ID5})^{ID3}->g^{ID3 ID4 ID5}

For the entity ID4 (MAC₄):(g^{ID3 ID5})^{ID4}->g^{ID3 ID4 ID5}

For the entity ID5 (MAC₅):(g^{ID3 ID4})^{ID5}->g^{ID3 ID4 ID5}

Each of the entities will then be able to compute the integrity pattern from a hashing algorithm of SHA1 type, and incorporate it in the ETHERNET frame in order to define the partitioning between the virtual networks by verification of the integrity pattern. The partitioning is represented by solid line arrows Dj in FIG. 7.

In the example described hereinabove, an entity is, for example, an element usually used in an Ethernet network and the flows exchanged are IP flows. Without departing from the framework of the invention, the method and the device described previously can be used in any system that implements entities that can communicate with each other by trust or partitioning group. The router according to the invention is therefore an entity that makes it possible to create trust groups, and direct the public values of each of the entities in order to enable them to create a secret element associated with each of the groups. Each entity has crypto capabilities (DH). The router has only capabilities to manage group rules and the associated protocol.

In the context of the software domain, the invention can be implemented with software bus techniques (middleware), in which the entities are represented by the concept or software services that are interconnected (between themselves according to a directory service). The router according to the invention will then be a particular service that can be accessed by all the other services. These other services must, on start up, and initialization of the machines (starting up processes or applications), create the DH public value and send each DH public value to the router service (via the software bus) which will then be responsible for sending the values to the services of one and the same trust group.

In the context of the hardware domain, the principle of the invention can be implemented with cards interconnected by a common hardware bus. The principle is then the same as that described previously. The cards act as the entities described previously and the router makes it possible to generate groups within which certain cards are authorized to communicate with each other.

The application to partitioned networks is also possible. For example, the invention is used for Ethernet/IP networks via a virtual local area network (or VLAN) system based on switches or based on routers in the VPN (Virtual Private Network) case.

The invention notably offers the following benefits: simplified configuration and flexibility in the parameterizing of the elements in a virtual network, and on the other hand, security in terms of integrity and confidentiality of the communication flow between the elements forming a virtual network.

To sum up, the method and the system according to the invention are based on the distribution of the notion of trust and of groups between the router and the communication nodes, and therefore of managing the creation of dynamic keys in a partitioned manner, in which the router has no concept of cryptographic security but simply a notion of trust group, whereas the nodes individually support this cryptographic capability but without the concept of security associations. The invention therefore allows effective separation between group management and the dynamic securing of these said groups.

1- A method for routing exchange flows of public or non-sensitive values for creating common keys between a number of areas in a system in which the entities communicate with each other by trust group, said method comprising at least the following steps:
each entity generates a public value and communicates this public value to a router, then each of the entities sends a message to the router with its public value g^{IDi},
said router has a mapping table correlating a virtual network number and the MAC addresses of the associated entities,
said router recovers all the public values transmitted by the entities by associating them with their MAC address, thus the public value g^{ID1} associated with the address MAC₁ of the entity 1 and so on for the subsequent entities 2 to N, g^{ID2}, address MAC₂, g^{IDN}, address MAC_{N}, and retransmits, to each of said entities associated with a virtual network based on the mapping table of each entity, a public value or secret value of another entity belonging to the same trust group, this step being repeated for all the entities,
each entity recovering the public value of another entity belonging to the same trust group then determines the value of the encryption key common to the entities of one and the same trust group,
an entity belonging to one and the same trust group uses this key to encrypt the data to be transmitted to another entity.

2- The method as claimed in claim 1, wherein it uses the Diffie-Hellman protocol to generate the public values and the encryption key.

3- The method as claimed in claim 1, wherein it incorporates an integrity pattern in the data frame.

4- The method as claimed in claim 3, wherein it uses a hashing algorithm to determine the integrity pattern.

5- The method as claimed in claim 1, wherein the data are exchanged in the form of an Ethernet frame and the protocol used is the IP protocol.

6- A system for routing exchange flows of public or non-sensitive values for creating common keys between a number of areas, in a system in which the entities communicate with each other by trust group, said system comprising at least the following elements:
an entity comprises a cryptography module suitable for generating a public value and a common secret,
a routing device comprising a mapping table establishing the links that exist between the virtual network numbers and the MAC addresses of the associated entities,
communication means between the routing device and the entities so that an entity transmits a public value to the routing device, said routing device transmits said public value to another entity belonging to the same trust group and an entity determines the value of the key to encrypt its data.

7- The system as claimed in claim 6, wherein the cryptography module uses the Diffie-Hellman mechanism.

8- The system as claimed in claim 6, wherein the system is an Ethernet communication network implementing the IP protocol.
